(19) United States
(12) Patent Application Publication
(10) Pub. No.: US 2003/0229706 A1
(43) Pub. Date: Dec. 11, 2003

(54) Non-textual representation of access activities regarding a resource

(76) Inventor: Do-Pil Park, Redwood City, CA (US)

Correspondence Address: SKADDEN, ARPS, SLATE, MEAGHER & FLOM LLP, ATTN: JAN STEELE, 525 UNIVERSITY AVENUE, SUITE 1100, PALO ALTO, CA, 94301, US

(21) Appl. No.: 10/453,979

(22) Filed: Jun. 4, 2003

Related U.S. Application Data
(60) Provisional application No. 60/386,051, filed on Jun. 5, 2002.

(51) Int. Cl. G06F 15/16; G06F 17/60

(52) U.S. Cl. 709/229; 705/26; 705/35; 713/201

(57) ABSTRACT

Techniques are disclosed to present an authorized user of a resource with a non-textual representation of characteristics regarding a historical record of access attempts to the resource while the authorized user accessing the resource. Such techniques may be further enhanced by providing the capability to notify an investigatory entity of undesired access attempts or by premising the presentation of such a non-textual representation upon the authentication of the authorized user. The presentation of the non-textual representation may be configured by the authorized user and may also be premised upon reaching a certain threshold of undesired access attempts. Such techniques may utilize a user interface subsystem that interacts with a access management subsystem.

### CROSS-REFERENCE TO RELATED APPLICATION

This application claims the benefit of U.S. Provisional Application No. 60/386,051, filed Jun. 5, 2002.

### FIELD

This application relates generally to non-textual representations of data, and more specifically, to non-textually representing activities relating to the access of a resource by multiple individuals.

### BACKGROUND

Providing authorized users with remote access to resources has become prevalent with the use of network communications technologies, such as the Internet. Examples of such remote access to resources range from specialized situations to everyday occurrences, including, without limitation, remotely logging into a supercomputer (i.e., the resource being supercomputer time), remotely logging into a business's intranet (i.e., the resource being documents, services, and/or other information available on the intranet), making a purchase at a store with a credit card (i.e., the resource being the credit card account or line of credit or other form of financial account), and withdrawing cash from an ATM machine (i.e. the resource being the bank checking account or available balance). The resource may include any type of service, product, data or other resource that can be accessed multiple times. Such resources may be shared by multiple authorized users or used only by a single authorized user. For example and without limitation, a supercomputer or an intranet may be accessed by any number of authorized users, while most ATM cards typically have only one authorized user.

However, remote access to resources also increases the opportunities for unauthorized, or authorized but excessive utilization of the resources. For example and without limitation, fraudulent use of credit cards is rampant in the online environment—some reports have estimated that 20 to 40 percent of all online purchase attempts are fraudulent, and the Federal Trade Commission has reported that the combined losses to the credit card industry and to cardholders exceed $2 billion annually. Moreover, remote access also increases the opportunity and ease for consumer credit card overuse

Despite such risks, there currently exists no convenient method for a user to view a historical record of characteristics relating to a resource while accessing that resource. When an authorized user logs into a UNIX-based system, for example, he is often provided with a text message indicating the last login time, and possibly the number of failed logins since that last login. However, such textual messages are limited in their capability to convey more than a small amount of information. If, for example, a user were presented a textual display of logins for the past week, the user might skip over such information due to the inconvenience of deciphering the textual display. Similarly, while computer systems often offer system utilities (e.g., UNIX commands such as “top” or “ps” or Windows NT Task Manager) to monitor computer usage, these utilities either do not enable an authorized user to distinguish between his own usage and others' usage, or only offer a current rather than a historical record of usage.

Similarly, in other environments, there currently exists no method for a user to view such historical records while accessing the resource. For example and without limitation, during an online credit card purchase transaction, an authorized user cannot readily determine whether he has been overusing the credit card or whether there has been recent unauthorized use of the credit card. Rather, in order to inquire about such information, the user must initiate contact with the card company or issuing bank independently of the credit card transaction, perhaps through a different Web page or by telephone.

SUMMARY

This application discloses various embodiments of techniques for displaying characteristics, relating to a resource that is accessible to one or more authorized users, while at least one of the users is accessing (or attempting to access) the resource. The techniques include monitoring attempts to access the resource over a certain time interval and presents a historical record of one or more characteristics of such access attempts. For example and without limitation, in one embodiment, the resource may be a credit card account and the access attempts could be purchase transactions. In such an embodiment, characteristics relating to the credit card account could include, without limitation: (a) whether purchase transactions are successful; (b) the date and time of such transactions; (c) the amount and geographic area of such transactions; and/or (d) any other characteristic relating to status of the credit card account or related purchase transactions. More specifically, by presenting a non-textual representation of such characteristics, an authorized user is enabled to readily distinguish authorized from unauthorized access (or access attempts). The authorized user may include any user(s) who is/are authorized to access a resource, which may, depending on the implementation, include (without limitation) owners of the resource, users permitted to use the resource by the owners (e.g., family members, friends, etc.), and/or managers of the resource. Similarly, as used herein, a non-textual representation being presented to the user, while the user is accessing the resource may occur: (1) before actual exploitation of the resource (e.g., before confirming an amount to be disbursed from an ATM machine, but after authorizing the user); (2) during actual exploitation of the resource (e.g., waiting—idle time—for the disbursement of cash from an ATM after confirming the amount to be disbursed); and/or (3) after actual exploitation of the resource (e.g., after disbursement of the cash, but before retrieving the ATM card and leaving the machine). Thus, an authorized user of a resource is made aware of characteristics associated with that resource and may initiate appropriate actions, in the course of accessing the resource. For example and without limitation, the user may realize that he has overused a credit card and decide to forego the current transaction. Or, the user may notice—despite not purchasing anything with the credit card during the past week—that one or more successful purchase transactions have been made on the card within the week, providing him an opportunity to alert a manager or investigate for possible fraudulent activity.

### BRIEF DESCRIPTION OF THE FIGURES

FIG. 1 depicts operation of an exemplary user interface subsystem.

FIG. 2 depicts operation of an exemplary access management subsystem.

FIG. 3 illustrates an exemplary embodiment of a non-textual representation of access to a resource.

FIG. 4 presents another exemplary embodiment of a non-textual representation of access to a resource.

### DETAILED DESCRIPTION

This detailed description first explores exemplary environments in which the techniques disclosed herein may be utilized, and then provides various embodiments of non-textual representations within such exemplary environments. However, those skilled in the art will recognize that such environments are merely illustrative and that the techniques may be utilized in any situation where a user can access a resource multiple times over the course of time.

A. Exemplary Environments

As one exemplary environment, consider an online credit card system. The credit card (or card) may include any type of access card or account, including without limitation, credit cards, debit cards, corporate cards, smart cards, gift cards, charge cards, bank cards, prepaid cards (whether of the stored value type or otherwise), and any other type of mechanism or account that can be used to access resources, whether financial or otherwise. An exemplary credit card environment, for example and without limitation, might include the use of a card to purchase goods or services over the Internet. When a user desires to purchase goods or services online, he may visit a merchant's Web site, choose the goods or services to purchase, provide payment information (such as a name, address, credit card number, expiration date, email address, etc.), and then click a confirmation, purchase, or buy button, or some other form of authorization. During such purchase attempts, the system may record characteristics relating to purchase, including without limitation, payment information submitted by the user, payment information generated by the merchant (such as merchant name, purchase price, date/time of purchase attempts, etc.), as well as the success or failure of the purchase attempt. By recording the characteristics of such purchase attempts, the system can thereby create, maintain, and update a historical record of past and present purchase attempts, whether initiated and/or completed. Then, before, upon, or after a request to the cardholder to authorize the transaction, the system can display to the user a non-textual representation of one or more characteristics (e.g., date/time, merchants, purchase price, etc.) of past attempts to use the credit card, enabling the cardholder to immediately assess the status of his account.

Some credit card purchase environments include a process to authenticate a user before enabling the user to authorize a purchase. For example and without limitation, Visa has recently launched a program called “Verified by Visa,” and MasterCard has also launched a program called “Secure Payment Application.” In such (and other similar) environments, display of the aforementioned characteristics can be conditioned upon successful user authentication, so that unauthenticated users will not have access to the authenticated user's information. For example and without limitation, upon authentication of the user, the system may then display to the user the non-textual representation of past attempts to use the credit card, thereby enabling the user to make an informed decision regarding his current purchase transaction before he authorizes the transaction. Alternatively, the system may display to the user the non-textual representation of past attempts to use the credit card after both authentication and authorization of the current purchase transaction.

Another exemplary environment may involve access to a user's account in a traditional offline card purchase transaction. For example and without limitation, when a user uses his card to purchase goods at a merchant's store, he may receive a purchase receipt slip (or other physical media) that he must sign in order to authorize the purchase. Printed upon the purchase receipt slip (or other physical media) may be a non-textual representation of past successful or unsuccessful purchase attempt under the user's account. Such a non-textual representation would enable the user to determine whether or not unauthorized users (as well as other authorized users) have been accessing the user's account, and thereby enable the user to authorize the present transaction with his signature with knowledge of such past access attempts. Those skilled in the art will recognize that the techniques herein may be used in any offline environment in which a user may receive a receipt slip for the purchase of a good or service, including without limitation, restaurants, stores, etc.

While a purchase is a typical transaction in the case of a credit card, those skilled in the art will readily appreciate that other types of transactions are associated with other types of cards or accounts. Hence, references to “purchase” should be understood to include other transaction types appropriate to other kinds of cards or accounts.

Another exemplary environment may involve access to a supercomputer, computer network, or any other computer system. For example and without limitation, upon a successful login into such a computer system, an authorized user, may be presented with a non-textual representation of past successful and/or unsuccessful logins under the authorized user's account. As such, the authorized user will be able to determine whether or not unauthorized users have been attempting to login under the guise of the authorized user, and whether such attempts have been successful.

Another exemplary environment may involve access to funds in a checking account through an ATM machine. For example and without limitation, upon a successful authentication of an authorized user (e.g., entry of a PIN number), the ATM machine may either present the authorized user an option or automatically display a non-textual representation of the past successful or unsuccessful attempts to use the ATM card. As such, the authorized user will be able to discern whether or not unauthorized users have been attempting (either successfully or unsuccessfully) to obtain cash from the authorized user's bank account. Additionally, an authorized user will also be able to assess whether other authorized users, such as other family members, have been also withdrawing cash from the bank account.

B. System Operation

The following sets forth, without limitation, exemplary structures in which the techniques disclosed herein may be implemented. However, those skilled in the art will recognize that such implementations are merely illustrative, and that many other equivalent implementations can be used, depending on the particular characteristics of the operating environment and the specific information to be displayed. In one exemplary structure, an overall system may comprise: (1) a user interface subsystem that interacts with users; and (2) an access management subsystem that maintains characteristics of the resource as well as attempts to access the resource. In many implementations, the subsystems will be implemented as software stored on a computer-readable medium (including, without limitation, RAM, hard disks, flash memory, optical media, etc.) and executed on a processor (including, without limitation, general purpose microprocessors, dedicated processors, ASICs, PLAs, PALs, etc.). The subsystems could even be implemented on hardware or a combination of software and hardware depending on the desired operating environment.

1. Exemplary User Interface Subsystem

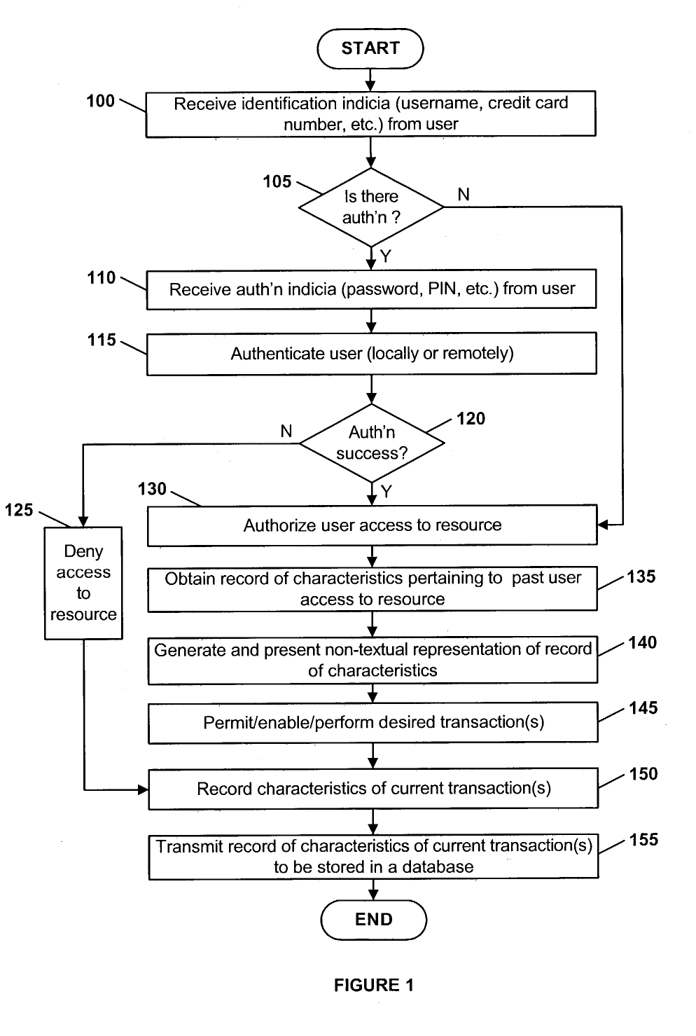

FIG. 1 illustrates operation of an exemplary user interface subsystem. Such a user interface subsystem may be implemented in the context of an ATM machine, a computer login display, a merchant web site, a store's credit card system, and/or any other system that can interact with a user and retrieve information from the user. The user interface may be implemented using applets, script files, and other known programming techniques.

As shown in FIG. 1, the user interface subsystem receives identification indicia of a user in order to authorize such a user's access to the resource (step 100). Such identification indicia may be obtained, for example and without limitation, when the user: (1) swipes a card through a card reader; (2) types a username; or (3) enters a credit card number. Those skilled in the art will recognize that other methods of obtaining a user's identification indicia may be used, including without limitation, use of smart cards or use of biometrics (e.g., voice, etc.). In some exemplary embodiments, an authentication process may be implemented in order to verify that the user is the entity corresponding to the identification indicia (step 105). If so, the user interface subsystem receives user authentication indicia in order to authenticate the user (step 110). Such authentication indicia may include, for example and without limitation, a password, PIN, or any other indicia that can authenticate the user. After receiving the authentication indicia, the user may be authenticated. Such authentication may be performed locally, at the user interface subsystem, itself, or remotely, for example and without limitation, at a dedicated authentication server (step 115). If the authentication was successful (step 120), then the user interface subsystem may authorize the user (step 130) and obtain a historical record of characteristics pertaining to the user's access of the resource (step 135). Such historical records may be retrieved, for example and without limitation, by querying a database remote from the user interface subsystem, or alternatively, within a local system that incorporates the user interface subsystem. The “database” may include a relational database, an object-oriented database, and virtually any other program or medium for storing information in a retrievable format.

Upon retrieving the historical record, the user interface subsystem may generate and present a non-textual representation of part or all of the historical record to the user (step 140). Alternatively and without limitation, generation of the non-textual representation could occur remote from the user interface subsystem, with the non-textual representation being subsequently transmitted to the user interface subsystem. The presentation of the non-textual representation to the user by the user interface subsystem enables the user to make an informed decision regarding making transactions with respect to the resource (e.g., purchasing goods, withdrawing cash, etc.). Thus, the presented characteristic(s) should indicate more than merely the occurrence of a past access attempt.

The user interface subsystem also facilities, enables, and permits the user to execute such currently desired transactions (step 145). The user interface subsystem also records the characteristics related to such current transactions (step 150) and ultimately transmits such characteristics to be stored in the database (step 155).

Returning now to step 115, if authentication was unsuccessful, the user interface subsystem will deny the user access to the resource (step 125). In many implementations, the user interface subsystem will nevertheless record the characteristics of such an unsuccessful transaction (step 150), and transmit the record to be stored in the database (step 155).

2. Exemplary Access Management Subsystem

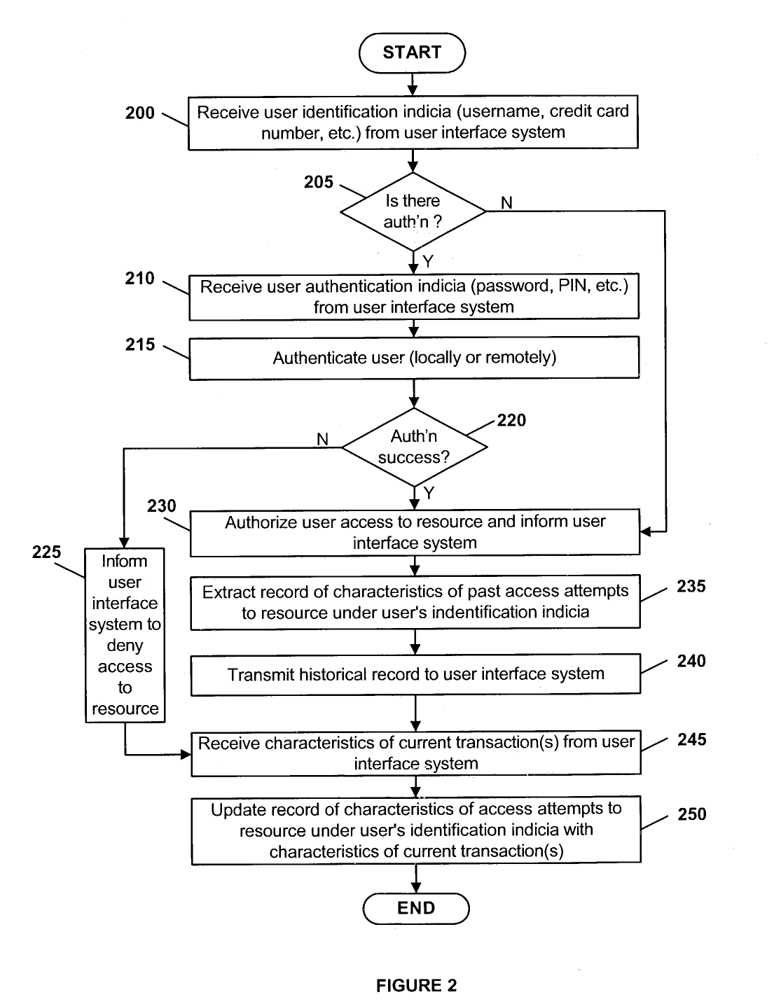

FIG. 2 illustrates operation of an exemplary access management subsystem. This exemplary access management subsystem interacts with the user interface subsystem, providing and receiving information to and from the user interface subsystem.

For example and without limitation, the access management subsystem may receive user identification indicia such as a username or credit card number from the user interface (step 200). If there is an authentication process (step 205), the access management subsystem may also receive user authentication indicia (e.g., a password, PIN, etc.) from the user interface subsystem (step 210) and authenticate the user (step 215), if the user interface subsystem does not perform such authentication itself. If the authentication is successful (step 220), the access management subsystem may authorize user access to the resource and inform the user interface subsystem of such authorization (step 230). Subsequent to such user authorization, the access management subsystem may extract from a database a historical record of characteristics of user access attempts to the resource under the user's identification indicia (step 235). After such extraction, the system may transmit part or all of the historical record to the user interface subsystem to display to the user (step 240). Alternatively, the system may also have the capability to generate a non-textual representation of the historical record and transmit such a non-textual representation to the user interface subsystem. Additionally, if the user ultimately decides to conduct current transactions with regard to the resource (e.g., purchase goods, withdraw cash, etc.), the user interface subsystem may send and the access management subsystem would receive characteristics for the current transactions made by the user (step 245). Upon receiving such characteristics, the access management subsystem may update the database record of characteristics of an access attempts to the resource under the user's identification indicia (step 250).

3. Other Variations

While the foregoing has described the user interface subsystem and access management subsystem as different subsystems, those skilled in the art will readily observe that the structures, functionalities, and order of steps in these systems can vary and may be integrated into a single system or further multiple subsystems without departing from the general spirit of the techniques disclosed herein. For example and without limitation, the presentation (and/or generation) of the non-textual representation of the historical record need not necessarily precede the system's facilitation of current transactions. Similarly, the presentation (and/or generation) of the non-textual representation could incorporate both the historical record of characteristics as well as a record of the current transactions. Furthermore, displaying the non-textual representation could occur automatically, for example and without limitation, after exceeding a predetermined threshold of access attempts. As used herein, such a “threshold” could, for example and without limitation, be premised upon the number of failed or unauthorized attempts, the aggregate dollar value of successful attempts, or any other characteristics or combination of characteristics that can define a predetermined threshold. For example and without limitation, the user interface subsystem in an online credit card environment may automatically display the non-textual representation when ten access attempts within a certain time interval have failed, or alternatively, when one successful access attempt within the time interval involved a purchase of over a certain dollar amount.

C. Non-Textual Representation

The following sets forth, without limitation, various exemplary implementations of techniques for non-textually displaying attempts to access a resource. However, those skilled in the art will recognize that such implementations are merely illustrative, and that many other equivalent implementations can be used, depending on the particular characteristics of the operating environment and the specific information to be displayed.

For example and without limitation, one exemplary non-textual representation of characteristics of access attempts may pertain to access attempts that have occurred over a certain time interval (e.g., past week, past month, etc.). In one exemplary implementation, this may take the form of an activity bar. The time interval may or may not be configurable by an authorized user. Additionally, in alternative embodiments, the form of the non-textual representation itself may also be configurable. For example, while accessing the resource, an authorized user may be able to select from a variety of different non-textual representations in order to display the characteristics in a form which best suits him.

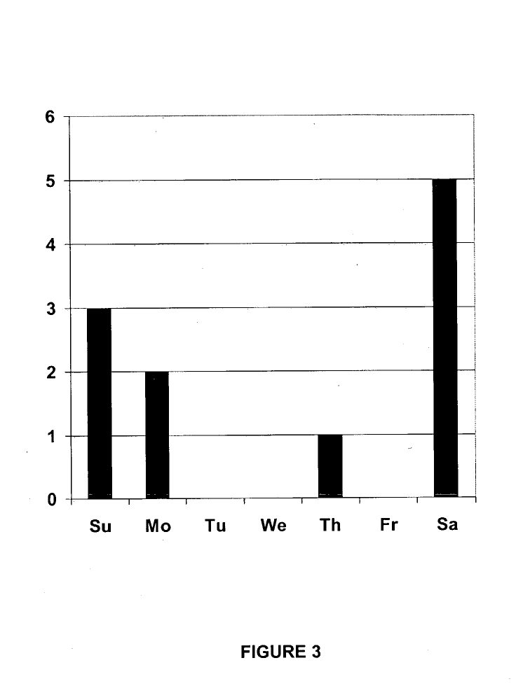

FIG. 3 illustrates one exemplary embodiment of a non-textual representation of characteristics for a transactional environment. In particular, FIG. 3 includes a chart indicating the number of transactions that have been made on a credit card during the past week. Such a chart enables the user to determine whether or not there have been fraudulent transactions made with his credit card, or whether he has himself made excessive purchases. For example, if the user only made one purchase on Sunday, then the fact that the display shows three purchases indicates that two were fraudulent.

Those skilled in the art will recognize that the exemplary embodiment of FIG. 3 may be enhanced or modified to provide more or different characteristics regarding the credit card accesses. For example and without limitation, rather than representing number of transactions as the vertical axis in FIG. 3, such a vertical axis could represent the dollar amount spent per day. Another aspect might provide an option for the authorized user to dynamically change the characteristics (e.g., dollar amount, number of transactions, etc.) that are presented in the non-textual display as well as the time interval (e.g., week(s), month(s), etc.) that is displayed.

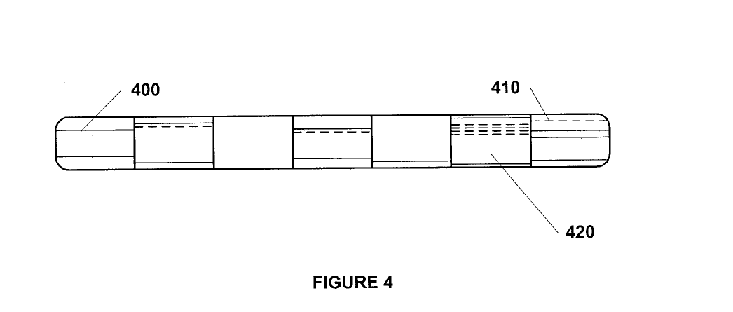

Similarly, FIG. 4 illustrates another exemplary embodiment of a non-textual representation of characteristics. In particular, FIG. 4 displays a non-textual representation of successful and unsuccessful login activities for the past week for a computer system. The seven boxes represent the past seven days, and the height of each box represents the 24 hours in the day. Different indicia represent different types of access attempts. For example, in a simple binary display scheme, a solid band, such as 400, could represent a successful login, while a dotted, dashed or broken band, such as 410, could represent a failed login attempt. As can be seen on the day represented by 420, several failed login attempts were made, thereby indicating suspicious activity. Such a non-textual representation enables an authorized user to quickly assess potential break-in activity and, for example, either notify the manager of the computer system or change his own password. Those skilled in the art will recognize that the exemplary embodiment of FIG. 4 may be enhanced or modified to provide more characteristics regarding login activities. For example and without limitation, the solid bands, representing successful logins, could be thickened to indicate the duration of a login session. Alternatively, in a color display scheme, different colors could also be used to display the different bands (e.g., green for successful logins and red for unsuccessful).

Other forms of non-textual representations could also incorporate further indicia to provide and display greater levels of differentiation. For example and without limitation, in an online credit card system, an account may have multiple authorized users (e.g., husband and wife). In a non-textual representation utilizing a color display scheme, different colors could be used to denote particular users (authorized or unauthorized) attempting to access the system (e.g., green for the husband, yellow for the wife, red for all others).

In general, the display could use any combination of graphics, colors, symbols, and other forms of non-textual information to convey information to the user. Further, “nontextual” should not be understood to absolutely prohibit all use of alphanumeric or other textual elements. Rather, any alphanumeric symbols should be used in a non-semantic fashion. For example, alphanumeric characters could be used to denote dates, quantities, or even within secondary pop-up windows that appear when a user clicks a graphical, symbolic or other element of a primary display. As an example of the latter, in FIGS. 3 and 4, when the user clicks on a bar, a secondary window could pop-up with additional textual information about the purchases (date, time, amount, merchant name, etc.). If all of this textual information had been presented for every transaction at the top level of the display, many users might find the display too cumbersome to use because of information overload. Thus, in many implementations, it will be preferable for any textual information to appear as pop-up windows, as clickable links, or otherwise secondarily to elements of a primarily non-textual display.

D. Notification of Investigatory Entity

Another exemplary aspect of the techniques disclosed herein includes exemplary mechanisms to notify a user, administrator, security, or other investigatory entity upon discovery of unauthorized access (or access attempts). For example and without limitation, in one exemplary implementation, the system may automatically notify such investigatory entity when the number of unauthorized access attempts exceeds a threshold. The investigatory entity may include any individual, group of persons, procedures, rules, services, systems or mechanisms that may be used to investigate possible unauthorized activity regarding access to a resource.

For example and without limitation, in such an exemplary automatic notification implementation, the notification could be sent by the system to the investigatory entity regardless of whether the authorized user is currently accessing the resource. As desired, the system could automatically inform the authorized user of such notification. For example, in one implementation, the system could inform the user that such notification has been sent when that user subsequently accesses the resource (referred to as “in-band”). Such information could be incorporated into a non-textual representation, for example, taking the form of special highlighting of the unauthorized access or usage indicators, a separate message box, or still other techniques that will be known to those skilled in the art. Alternatively, in another implementation, the system could inform the user even when the user is not accessing the resource (referred to as “out-of-band”). In such an out-of-band implementation, the system could inform the user through mail, email, phone, or still other available messaging techniques.

Alternatively, the system may provide the capability for an authorized user to manually notify such investigatory entity. In one exemplary in-band implementation, the system could incorporate a button to click or other notification mechanism with the non-textual representation of characteristics of the resource. In one exemplary out-of-band implementation, the system could, for example and without limitation provide a telephone number to call or Web site to visit. Those skilled in the art will recognize that the foregoing notifying mechanisms are merely illustrative and that there are a variety of other equivalent in-band or out-of-band notifying mechanisms.

Depending upon how such investigatory entity operates, notification by the system may be weighted accordingly to determine whether, for example, further fraud detection efforts should be undertaken. For example and without limitation, if notification of investigatory entity occurs prior to authorization or authentication, such notification may be weighted less in such a determination than if the notification had occurred subsequent to authorization or authentication.

The various embodiments described above should be considered as merely illustrative. They are not intended to be exhaustive or to limit any claimed invention to the forms disclosed. Those skilled in the art will readily appreciate that still other variations and modifications may be practiced without departing from the general spirit of the techniques set forth herein.

What is claimed is:

1. A method of non-textually displaying a historical record of access attempts to a protected resource, comprising:
(a) granting permission for a user to access a user-specific aspect of a protected resource;
(b) obtaining a record of past access attempts, purportedly of said user, from an access management database;
(c) providing, for displaying to said user, a representation of at least a portion of said record:
(i) capable of indicating improper access attempts over a reporting interval;
(ii) in a non-textual manner without primarily conveying information via semantic content;
(iii) while said user is connected to said resource;
(iv) thereby enabling said user to initiate corrective action upon detection, if at all, of improper access attempts; and
(d) updating said record by transmitting at least one characteristic of said access to said access management database.

2. The method of claim 1 where said displayed representation indicates both improper and proper access attempts.

3. The method of claim 1 where said displayed representation differentially displays information reflecting access attempts by a plurality of authorized users.

4. The method of claim 1 where said displayed representation includes a duration of one or more past access attempts.

5. The method of claim 1 where said displaying includes differentially displaying information pertaining to proper and improper access attempts.

6. The method of claim 1 where said displayed representation further includes a secondary level of information using a textual display.

7. The method of claim 1 where said displayed non-textual representation includes at least one characteristic of a past attempt to use the resource, said characteristic indicating more than simply the occurrence of said past attempt.

8. The method of claim 1 where said displaying while said user is connected to said resource includes transmitting said representation for printing on a card charge slip at a merchant's printer.

9. The method of claim 1 where said displaying while said user is connected to said resource includes printing said representation of said portion of said record on a physical medium.

10. The method of claim 1 where said displaying is conditioned on data in said record indicating satisfaction of an economic threshold.

11. The method of claim 1 where said displaying while said user is connected to said resource occurs in an offline manner.

12. The method of claim 1 where said displayed non-textual representation includes an activity bar.

13. The method of claim 1 where said displayed non-textual representation includes the use of color.

14. The method of claim 1 where said access to said resource is shared by a plurality of authorized users.

15. The method of claim 1 where said record includes an identifier of an improper transaction.

16. The method of claim 1 where said transmitted characteristic includes purchase information.

17. The method of claim 1 where said access includes a credit card purchase transaction.

18. The method of claim 1 further comprising informing an investigatory entity after detecting an unauthorized access attempt.

19. The method of claim 1 where said displaying is conditioned on said record exceeding a predetermined threshold of improper access attempts.

20. The method of claim 1 where said resource includes a financial account.

21. A system for displaying characteristics relating to a resource accessible to at least one authorized user, comprising:
(a) means for monitoring a plurality of access attempts to said resource over a time interval;
(b) means for creating a record of characteristics from said plurality of access attempts during said time interval; and
(c) means for displaying to said authorized user, while said authorized user is accessing said resource, a non-textual representation of said record in a manner capable of distinguishing an access attempt by said authorized user from those of an unauthorized user; and
(d) means for notifying an investigatory entity that a portion of said plurality of access attempts is unauthorized.

22. A system for maintaining a record of access attempts to a protected resource, and enabling a user to detect unauthorized access attempts, comprising:
(a) a user interface subsystem configured to:
(i) receive a request from an authorized user to conduct a transaction with a user-specific aspect of a protected resource;
(ii) obtain a record of past access attempts, purportedly of said user, from an access management database;
(iii) display to said user, a representation of at least a portion of said record:
(A) capable of indicating improper access attempts over a reporting interval;
(B) in a non-textual manner without primarily conveying information via semantic content;
(C) while said user is connected to said resource; and
(b) an access management subsystem configured to maintain said record of past attempts in said database.

23. A method of non-textually displaying a historical record of access attempts to a protected resource, comprising:
(a) receiving a request from an authorized user to conduct a transaction with a user-specific aspect of a protected resource;
(b) granting access permission to said user;
(c) receiving a record of past access attempts, purportedly of said user, from an access management database;
(d) displaying to said user, a representation of at least a portion of said record:
(i) capable of indicating improper access attempts over a reporting interval;
(ii) in a non-textual manner without primarily conveying information via semantic content;
(iii) while said user is connected to said resource;
(iv) thereby enabling said user to initiate corrective action upon detection, if at all, of improper access attempts;
(e) enabling updating of said record by transmitting at least one characteristic of said access to said access management database.

24. The method of claim 23 where said displayed representation differentially displays information reflecting access attempts by a plurality of authorized users.

25. The method of claim 23 where said displayed representation includes a duration of one or more past access attempts.

26. The method of claim 23 where said displaying includes differentially displaying information pertaining to proper and improper access attempts.

27. The method of claim 23 where said displayed representation further includes a secondary level of information using a textual display.

28. The method of claim 23 where said displaying while said user is connected to said resource includes printing said representation on a card charge slip at a merchant's printer.

29. A computer-readable medium including logic instructions for non-textually displaying a historical record of access attempts to a protected resource, said instructions when executed:
(a) granting permission for a user to access a user-specific aspect of a protected resource;
(b) obtaining a record of past access attempts, purportedly of said user, from an access management database;
(c) providing, for displaying to said user, a representation of at least a portion of said record:
(i) capable of indicating improper access attempts over a reporting interval;
(ii) in a non-textual manner without primarily conveying information via semantic content;
(iii) while said user is connected to said resource;
(iv) thereby enabling said user to initiate corrective action upon detection, if at all, of improper access attempts; and
(d) updating said record by transmitting at least one characteristic of said access to said access management database.
